(19) United States
(12) Patent Application Publication
(10) Pub. No.: US 2026/0169351 A1
(43) Pub. Date: Jun. 18, 2026

(54) SEGMENTED TEMPERATURE CONTROLLABLE WAVELENGTH CONVERSION DEVICE

(71) Applicant: HC PHOTONICS CORP., Hsinchu City (TW)

(72) Inventors: Ming-Hsien CHOU, Hsinchu City (TW); Jui-Yu LAI, Hsinchu City (TW); Chih-Rong CHEN, Hsinchu City (TW); Te-Hsin CHUANG, Hsinchu City (TW)

(21) Appl. No.: 18/985,923

(22) Filed: Dec. 18, 2024

(51) Int. Cl. G02F 1/377; G02F 1/355; H01S 3/04; H01S 3/109

(52) U.S. Cl. CPC G02F 1/3775; G02F 1/3558; H01S 3/0405; H01S 3/1095

(57) ABSTRACT

There provides a segmented temperature controllable wavelength conversion device, including a wavelength conversion unit, which includes a plurality of segments, wherein a first segment of the segments is configured to operate at a first temperature, a second segment of the segments is configured to operate at a second temperature, and the first temperature is different from the second temperature.

### BACKGROUND OF THE INVENTION

### 1. Field of the Invention

The present invention relates to a wavelength conversion device, and more particularly to a segmented temperature controllable wavelength conversion device, a fiber pigtailed waveguide mixer, and a free space coupled waveguide mixer.

### 2. Description of Related Art

Nonlinear optics is the branch of optics that describes the behavior of light in nonlinear media, and it involves the application of wavelength conversion from one wavelength of light to another wavelength of light.

FIG. 1 shows a schematic diagram illustrating the mechanism of a second harmonic generation (SHG).

The so-called second harmonic generation (SHG) is also known as frequency doubling, which can generate of light with a halved wavelength and a doubled frequency, with two photons destroyed and a single photon created with the halved wavelength and the doubled frequency. For example, when a (laser) input of wavelength of 1560 nm is input into the waveguide, it can output a (laser) output of wavelength of 780 nm. In the present specification, “nm” means nanometer.

However, the prior art waveguide as a whole can only operate at a single temperature, for example, 45 degrees in Celsius, so that it can convert only one input wavelength (for example, 1560 nm) into only one output wavelength (for example, 780 nm). Therefore, the prior art waveguide cannot be used in various applications.

Therefore, it is desirable to provide an improved wavelength conversion device to mitigate and/or obviate the aforementioned problems.

### SUMMARY OF THE INVENTION

The present invention aims to provide a wavelength conversion device having a plurality of structurally identical segments operating at different temperatures, which can be used in various applications by adjusting the temperatures for the respective segments.

According to one aspect of the present invention, there provides a segmented temperature controllable wavelength conversion device, including a wavelength conversion unit, which includes a plurality of segments, wherein a first segment of the segments is configured to operate at a first temperature, a second segment of the segments is configured to operate at a second temperature, and the first temperature is different from the second temperature.

The present invention further provides the following optional or preferable features that can be taken alone or in combination.

Optionally or preferably, the wavelength conversion unit may be formed of periodically poled lithium niobate (PPLN) or periodically poled lithium tantalate (PPLT).

Optionally or preferably, the wavelength conversion unit may be in a form of a bulk material with no cutting among the segments.

Optionally or preferably, the segments have the same periodical microstructures or different periodical microstructures.

Optionally or preferably, the segmented temperature controllable wavelength conversion device of the present invention may further include a plurality of thermal controllers, corresponding respectively to the segments and configured to respectively control a plurality of the temperatures of the segments.

Optionally or preferably, each thermal controller may be a chip of a thermal electric cooler (TEC).

Optionally or preferably, the segmented temperature controllable wavelength conversion device of the present invention may further include a plurality of thermal conductive units, each thermal conductive unit being arranged between a segment and a thermal controller.

Optionally or preferably, the segmented temperature controllable wavelength conversion device of the present invention may further include a plurality of thermal insulative units, arranged alternatingly with the thermal conductive units.

Optionally or preferably, the segmented temperature controllable wavelength conversion device of the present invention may further include a plurality of thermal sensors, configured to obtain the temperatures of the segments.

Optionally or preferably, the thermal sensors may be arranged respectively in the thermal conductive units.

Optionally or preferably, the first segment may be configured to convert a first input wavelength into a first output wavelength, and the second segment may be configured to convert a second input wavelength into a second output wavelength.

Optionally or preferably, the first input wavelength may be the same as the second input wavelength, but the first output wavelength may be different from the second output wavelength.

Optionally or preferably, the first input wavelength may be different from the second input wavelength, but the first output wavelength may be the same as the second output wavelength.

Optionally or preferably, the first input wavelength may be different from the second input wavelength, and the first output wavelength may also be different from the second output wavelength.

Optionally or preferably, the segmented temperature controllable wavelength conversion device may be capable of receiving at least two different input wavelengths and generating at least two different output wavelengths at a time.

Optionally or preferably, the first segment and the second segment may form a cascade structure, configured to perform a cascade wavelength conversion.

Optionally or preferably, the first segment may be configured to convert a part of an input into a first output, and the second segment may be configured to convert a remaining part of the input along with the first output into a second output.

Optionally or preferably, the cascade wavelength conversion may be: (i) a stage of second harmonic generation plus a stage of sum frequency generation; or (ii) a stage of second harmonic generation plus another stage of second harmonic generation; or (iii) a stage of second harmonic generation plus a stage of an optical parametric amplification; or (iv) a stage of second harmonic generation plus a stage of difference frequency generation; or (v) any combination of any two processes selected from second harmonic generation, sum frequency generation, optical parametric amplification, and difference frequency generation.

Optionally or preferably, a material variation or a thermal defect in a segment may be compensated by independent temperature control of the segment.

According to another aspect of the present invention, there provides a fiber pigtailed waveguide mixer, including an input fiber, an output fiber, and an aforementioned segmented temperature controllable wavelength conversion, connected between the input fiber and the output fiber.

According to still another aspect of the present invention, there provides a free space coupled waveguide mixer, including an input lens, an output lens, and a aforementioned segmented temperature controllable wavelength conversion device, arranged between the input lens and the output lens, wherein at least one free space may be left between the segmented temperature controllable wavelength conversion device and the output input lens or the segmented temperature controllable wavelength conversion device and the output lens.

Other objects, advantages, and novel features of the present invention will become more apparent from the following detailed description when taken in conjunction with the accompanying drawings.

### BRIEF DESCRIPTION OF THE DRAWINGS

FIG. 1 shows a schematic diagram illustrating the mechanism of a second harmonic generation (SHG);

FIG. 2 shows a schematic diagram of a segmented temperature controllable wavelength conversion device according to one embodiment of the present invention;

FIG. 3 shows a schematic diagram of a segmented temperature controllable wavelength conversion device performing a multiple wavelength conversion according to one embodiment of the present invention;

FIG. 4 shows a schematic diagram of a segmented temperature controllable wavelength conversion device performing a cascade wavelength conversion according to one embodiment of the present invention;

FIG. 5 shows a schematic diagram of a wavelength conversion waveguide including different portions having different optimal operating temperatures;

FIG. 6 shows a schematic diagram of a fiber pigtailed waveguide mixer according to one embodiment of the present invention; and

FIG. 7 shows a schematic diagram of a free space coupled waveguide mixer according to one embodiment of the present invention.

### DETAILED DESCRIPTION OF THE EMBODIMENT

Different embodiments of the present invention are provided in the following description. These embodiments are meant to explain the technical content of the present invention, but not meant to limit the scope of the present invention. A feature described in an embodiment may be applied to other embodiments by suitable modification, substitution, combination, or separation.

It should be noted that, in the present specification, when a component is described to have an element, it means that the component may have one or more of the elements, and it does not mean that the component has only one of the elements, except otherwise specified.

Moreover, in the present specification, the ordinal numbers such as “first” or “second” are used to distinguish a plurality of elements having the same name, and it does not mean that there is essentially a level, a rank, an executing order, or a manufacturing order among the elements, except otherwise specified. A “first” element and a “second” element may exist together in the same component, or alternatively, they may exist in different components, respectively. The existence of an element described by a greater ordinal number does not essentially mean the existent of another element described by a smaller ordinal number.

Moreover, in the present specification, the terms such as “top”, “bottom”, “left”, “right”, “front”, “back”, or “middle”, as well as the terms such as “on”, “above”, “under”, “below”, or “between”, are used to describe the relative positions among a plurality of elements, and the described relative positions may be interpreted to include their translation, rotation, or reflection.

Moreover, in the present specification, when an element is described to be arranged “on” another element, it does not essentially mean that the elements contact the other element, except otherwise specified. Such interpretation is applied to other cases similar to the case of “on”.

Moreover, in the present specification, the terms such as “preferably” or “advantageously” are used to describe an optional or additional element or feature, and in other words, the element or the feature is not an essential element, and may be ignored in some embodiments.

Moreover, in the present specification, when an element is described to be “suitable for” or “adapted to” another element, the other element is an example or a reference helpful in imagination of properties or applications of the element, and the other element is not to be considered to form a part of a claimed subject matter, except otherwise specified; similarly, in the present specification, when an element is described to be “suitable for” or “adapted to” a configuration or an action, the description is made to focus on properties or applications of the element, and it does not essentially mean that the configuration has been set or the action has been performed, except otherwise specified.

Moreover, in the present specification, the terms such as “system”, “apparatus”, “device”, “module”, or “unit”, refer to an electronic element, or a digital circuit, an analogous circuit, or other general circuits, composed of a plurality of electronic elements, and there is not essentially a level or a rank among the aforementioned terms, except otherwise specified.

Moreover, in the present specification, two elements may be connected to each other directly or indirectly, except otherwise specified. In an indirect connection, one or more elements may exist between the two elements.

Moreover, in the present specification, a value may be interpreted to cover a range within ±10% of the value, and in particular, a range within ±5% of the value, except otherwise specified; a range may be interpreted to be composed of a plurality of subranges defined by a smaller endpoint, a smaller quartile, a median, a greater quartile, and a greater endpoint, except otherwise specified.

### Segmented Temperature Controllable Wavelength Conversion Device

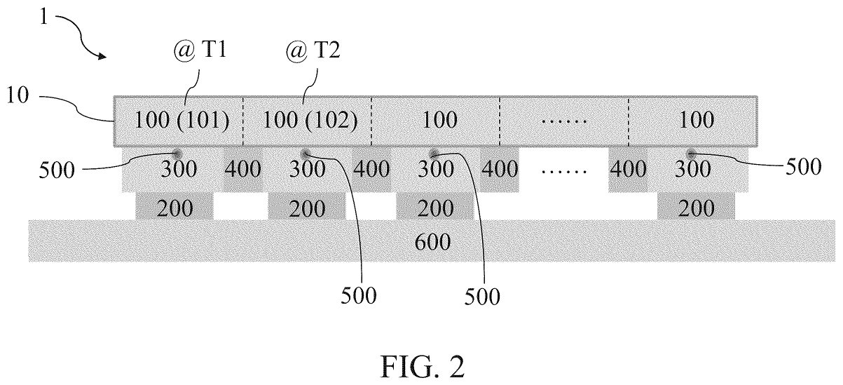

FIG. 2 shows a schematic diagram of a segmented temperature controllable wavelength conversion device 1 according to one embodiment of the present invention.

Typically, the segmented temperature controllable wavelength conversion device 1 can receive a laser input of an input wavelength and generate a laser output of an output wavelength.

### Wavelength Conversion Unit

Referring to FIG. 2, the segmented temperature controllable wavelength conversion device 1 mainly includes a wavelength conversion unit 10. The wavelength conversion unit 10 includes a plurality of segments 100. The present invention can implement a mechanism that among the plurality of segments 100, at least two segments 100 operate at different temperatures. In order to explain the aforementioned mechanism of the present invention, a first segment 101 and a second segment 102 are labeled in particular among the plurality of segments 100, wherein the first segment 101 is configured to operate at a first temperature T1, and the second segment 102 is configured to operate at a second temperature T2. The first temperature T1 is different from the second temperature T2. To go further, it is also possible that all segments 100 operate at different temperatures.

The wavelength conversion unit 10 may be formed of periodically poled lithium niobate (PPLN) or periodically poled lithium tantalate (PPLT), but not limited thereto. Any other material is still possible as long as it can implement wavelength conversion from an input wavelength into an output wavelength. The wavelength conversion unit 10 can be regarded as a waveguide. A PPLN waveguide or a PPLT waveguide is made by a high electric field poling technique, which forms a periodical microstructure on a lithium niobate (LN) waveguide or a lithium tantalate (LT) waveguide. Such microstructure can implement the function of wavelength conversion. Different microstructures may be formed depending on different demanded wavelength conversions, and they can be precisely optimized because they can be set to have different temperatures. In particular, according to the present invention, whether the plurality of segments 100 have the same periodical microstructure or different periodical microstructures, they can perform different wavelength conversions because they are set to have different temperatures.

Moreover, the wavelength conversion unit 10 may be in a form of a bulk material. The present invention does not physically cut the wavelength conversion unit 10 into the segments 100, nothing such as a free space existing between two adjacent segments 100. However, rather than complete cutting, some recesses may be formed on the wavelength conversion unit 10 to for example ease the assembly with other components, and these components will be discussed later.

The wavelength conversion unit 10 may be formed with a dimension of 10 to 50 mm×1.5 mm×2 mm, but not limited thereto.

### Thermal Controller

To implement the aforementioned mechanism of the present invention, the segmented temperature controllable wavelength conversion device 1 may further include a plurality of thermal controllers 200, corresponding respectively to the segments 100 and configured to respectively control a plurality of the temperatures of the segments 100. As shown in FIG. 2, each thermal controller 200 is arranged below a segment 100, and there may be other components existing between a thermal controller 200 and a segment 100. However, it is still possible that a thermal controller 200 directly contact a segment 100. Optionally or preferably, each thermal controller 200 may be a chip of a thermal electric cooler (TEC), but not limited thereto. Each thermal controller 200 can cool down or heat up the temperature of a segment 100 so as to implement the temperature control technology of the present invention.

### Thermal Conductive Unit

As shown in FIG. 2, the segmented temperature controllable wavelength conversion device 1 may further include a plurality of thermal conductive units 300, each thermal conductive unit 300 being arranged between a segment 100 and a thermal controller 200. The heat may be transmitted between the segment 100 and the thermal controller 200 by the thermal conductive unit 300. Each thermal conductive unit 300 may be formed of a material having high thermal conductivity, such as metal for example, but not limited thereto.

### Thermal Insulative Unit

Moreover, in order to precisely control the temperatures of the segments 100, a plurality of thermal insulative units 400 may be added in the segmented temperature controllable wavelength conversion device 1, and they may be arranged alternatingly with the thermal conductive units 300. That is, one thermal insulative unit 400 may be arranged between two adjacent thermal conductive units 300, as shown in FIG. 2, so that the two adjacent thermal conductive units 300 will not interference each other, and in particular, the thermal insulative unit 400 can block the heat from one thermal conductive unit 300 to another thermal conductive unit 300. Each thermal insulative unit 400 may be formed of a material having low thermal conductivity, such as plastic for example, but not limited thereto.

### Thermal Sensor

Furthermore, in order to monitor and/or control the temperatures of the segments 100, a plurality of thermal sensors 500 may be added in the segmented temperature controllable wavelength conversion device 1, and they may be configured to obtain the temperatures of the segments 100, one thermal sensor 500 corresponding to one segment 100. In particular, as shown in FIG. 2, the thermal sensors 500 are arranged respectively inside the thermal conductive units 300, but not limited thereto. The thermal sensors 500 may be arranged in any suitable locations as long as they can obtain the temperatures of the segments 100. Each thermal sensor 500 may be a thermistor, in particular a negative power thermistor (NTC), but not limited thereto.

### Base Plate

To support the aforementioned components, the segmented temperature controllable wavelength conversion device 1 may further include a base plate 600. As shown in FIG. 2, the base plate 600 may be arranged at the lowest location, and then, the controllers 200, the thermal conductive units 300 (with the thermal insulative unit 400 therebetween), and the wavelength conversion unit 10 are arranged in turn thereon, but not limited thereto. Other kinds of structures are also possible.

### Multiple Wavelength Conversion

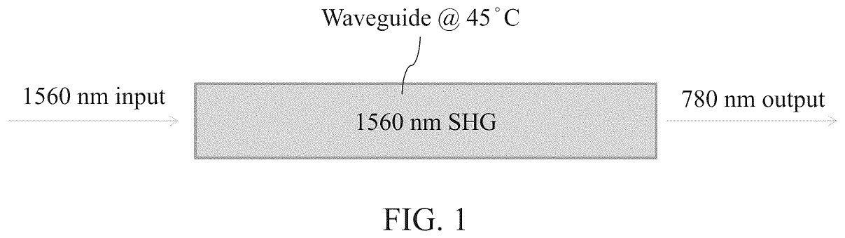

As previously mentioned, different wavelength conversions correspond to different microstructures formed in the wavelength conversion waveguide (for example, PPLN or PPLT). The prior art wavelength conversion waveguide has only one microstructure and is configured to operate at only one temperature, so that it is limited to perform a wavelength conversion from only one input wavelength into only one output wavelength, for example, limited to a second harmonic generation from an input wavelength of 1560 nm to an output wavelength of 780 nm, as shown in FIG. 1.

Now, according to the present invention, the wavelength conversion unit 10 is divided into the plurality of segments 100 set to different temperatures, so that different segments 100 can perform different wavelength conversions, in particular at the same time, even if they have the same microstructures. This is a mechanism called a “multiple wavelength conversion” in the present invention. Specifically say, the segmented temperature controllable wavelength conversion device 1 of the present invention is capable of receiving at least two different input wavelengths and generating at least two different output wavelengths at a time.

Referring back to FIG. 2, it is possible to define that the first segment 101 is configured to convert a first input wavelength into a first output wavelength, and the second segment 102 is configured to convert a second input wavelength into a second output wavelength. Regarding the input wavelength and the output wavelength, the following situations may occur:
(i) the segments 101 and 102 have the same input wavelength but different output wavelengths, because the segments 101 and 102 are set to have different temperatures and accordingly perform different wavelength conversions. Specifically say, the first input wavelength of the first segment 101 is the same as the second input wavelength of the second segment 102, but the first output wavelength of the first segment 101 is different from the second output wavelength of the second segment 102; or
(ii) the segments 101 and 102 have different input wavelengths but the same output wavelength, because the segments 101 and 102 are set to have different temperatures and accordingly perform different wavelength conversions. Specifically say, the first input wavelength of the first segment 101 is different from the second input wavelength of the second segment 102, but the first output wavelength of the first segment 101 is the same as the second output wavelength of the second segment 102; or
(iii) the segments 101 and 102 have different input wavelengths as well as different output wavelengths, because the segments 101 and 102 are set to have different temperatures and accordingly perform different wavelength conversions. Specifically say, the first input wavelength of the first segment 101 is different from the second input wavelength of the second segment 102, and the first output wavelength of the first segment 101 is also different from the second output wavelength of the second segment 102.

It should be noted that the case of more than two segments may be derived from the aforementioned case of two segments 101 and 102.

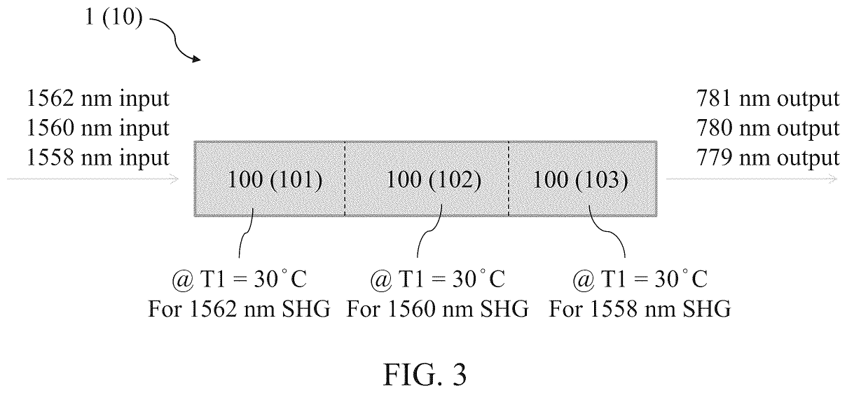

FIG. 3 shows a schematic diagram of a segmented temperature controllable wavelength conversion device 1 performing a multiple wavelength conversion according to one embodiment of the present invention.

As shown in FIG. 3, there are three segments 101, 102, and 103 in the wavelength conversion unit 10 of the segmented temperature controllable wavelength conversion device 1 (with other components omitted for simplifying the explanation), and they are respectively set to have different temperatures of 30 degrees, 45 degrees, and 60 degrees in Celsius. When three (laser) inputs of wavelengths of 1562 nm, 1560 nm, and 1558 nm are input into the wavelength conversion unit 10, it can output three (laser) outputs of wavelengths of 781 nm, 780 nm, and 779 nm. Specifically say, the first segment 101 set at 30 degrees in Celsius converts the input wavelength of 1562 nm into the output wavelength of 781 nm, the second segment 102 set at 45 degrees in Celsius converts the input wavelength of 1560 nm into the output wavelength of 780 nm, and the third segment 103 set at 60 degrees in Celsius converts the input wavelength of 1558 nm into the output wavelength of 779 nm. It should be noted again that, according to the present invention, whether the three segments 101, 102, and 103 have the same periodical microstructure or different periodical microstructures, they can perform different wavelength conversions because they are set to have different temperatures.

### Cascade Wavelength Conversion

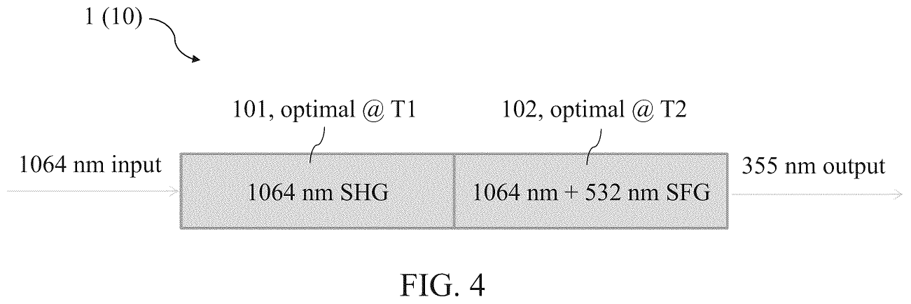

FIG. 4 shows a schematic diagram of a segmented temperature controllable wavelength conversion device 1 performing a cascade wavelength conversion according to one embodiment of the present invention.

The “cascade wavelength conversion” means that a former stage of wavelength conversion will affect a latter stage of wavelength conversion.

Taking a case of a two-stage cascade wavelength conversion, in a first stage, a part of an input is converted into a first output, and then, in a second stage, a remaining part of the input along with the first output are converted into a second output. For example, as shown in FIG. 4, in the first stage, an input wavelength of 1064 nm is converted through a second harmonic generation (SHG) into a wavelength of 532 nm, and then, in the second stage, a remaining wavelength of 1064 nm along with the wavelength of 532 nm are converted through a sum frequency generation (SFG) into a wavelength of 355 nm. The aforementioned values are merely examples to explain the cascade wavelength conversion, but are not meant to limit the scope of the present invention.

However, it is difficult to implement the cascade wavelength conversion in the prior art waveguide because intrinsically, each stage of wavelength conversion has its own optimal operating temperature, and once the waveguide has any material variations, different portions thereof will have their own optimal operating temperatures as well. However, in the prior art, the entire waveguide can only operate at the same temperature, which is not suitable for the cascade wavelength conversion to occur. In other words, the prior art waveguide has low yield in implementation of the cascade wavelength conversion.

Now, according to the present invention, the wavelength conversion unit 10 is divided into the plurality of segments 100, which can be controlled to operate at different temperatures, suitable for different stages of wavelength conversions, the aforementioned problems can be solved, and the cascade wavelength conversion can therefore be achieved.

Accordingly, in one embodiment of the present invention, in the wavelength conversion unit 10, the first segment 101 and the second segment 102 form a cascade structure, configured to perform a cascade wavelength conversion. The first segment 101 is configured to convert a part of an input into a first output, and the second segment is configured to convert a remaining part of the input along with the first output into a second output.

Several kinds of cascade wavelength conversions are possible, for example:
(i) SHG+SFG (THG): a stage of second harmonic generation plus a stage of sum frequency generation to form a third harmonic generation; or
(ii) SHG+SHG (FHG): a stage of second harmonic generation plus another stage of second harmonic generation to form a fourth harmonic generation; or
(iii) SHG+OPA: a stage of second harmonic generation plus a stage of an optical parametric amplification; or
(iv) SHG+DFG: a stage of second harmonic generation plus a stage of difference frequency generation; or
(v) any combination of any two processes selected from second harmonic generation, sum frequency generation, optical parametric amplification, and difference frequency generation.

In addition to the two-stage cascade wavelength conversion, more than two stages of wavelength conversions are also possible.

### Yield Improvement

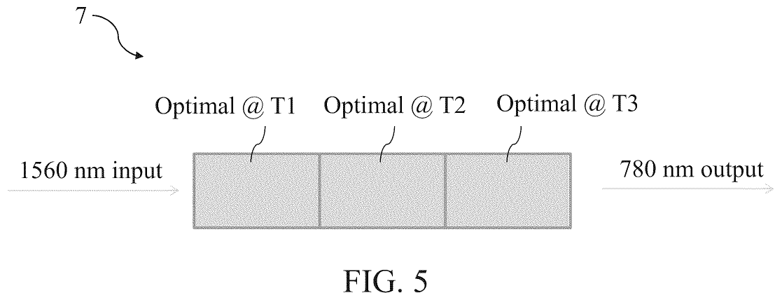

FIG. 5 shows a schematic diagram of a wavelength conversion waveguide 7 including different portions having different optimal operating temperatures.

A wavelength conversion waveguide may include different portions having different optimal operating temperatures, for example, T1, T2, and T3, as shown in FIG. 5, due to material variations or thermal defects in these portions. In the prior art, since the entire waveguide 7 can only operate at the same temperature, there must be some portions failing to operate at their optimal operating temperatures, resulting in that the entire waveguide has a bad performance. In the prior art, such waveguide is not usable and has to be discarded, so that the prior art waveguide is regarded to have low yield.

However, according to the present invention, the wavelength conversion unit 10 is divided into the plurality of segments 100, which can be controlled to operate at their own optimal operating temperatures. If the wavelength conversion unit 10 has any material variations or any thermal defects, they can be compensated by the temperature control technology of the present invention, the wavelength conversion unit 10 can therefore be recovered up to its original performance, and does not have to be discarded. This also improves yield thereof.

Accordingly, in one embodiment of the present invention, a material variation or a thermal defect in a segment 100 is compensated by independent temperature control of the segment.

### Product

The segmented temperature controllable wavelength conversion device 1 of the present invention is applicable to at least two kinds of products: a fiber pigtailed waveguide mixer and a free space coupled waveguide mixer, but not limited thereto. The details of such applications are explained as follows.

### Fiber Pigtailed Waveguide Mixer

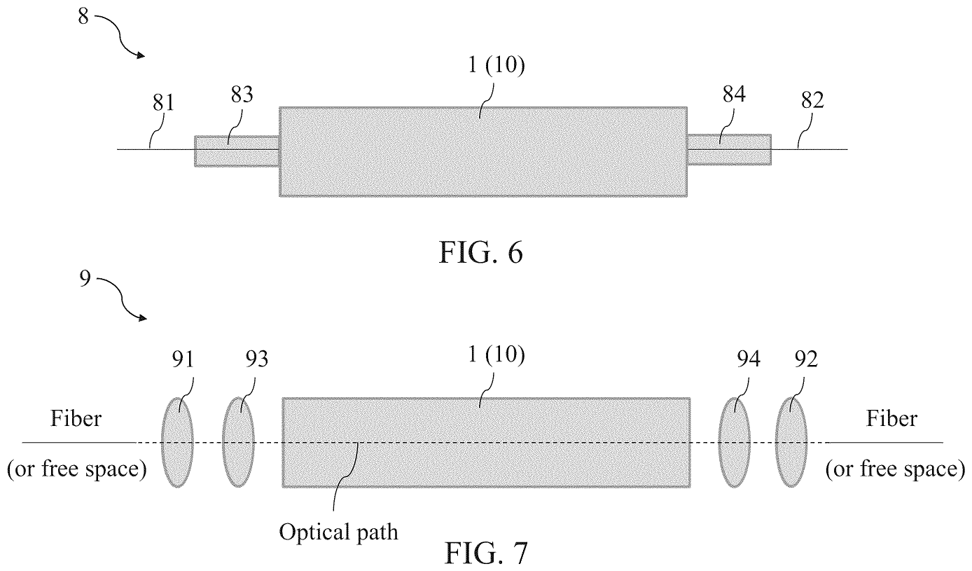

FIG. 6 shows a schematic diagram of a fiber pigtailed waveguide mixer 8 according to one embodiment of the present invention.

As shown in FIG. 6, an input fiber 81, an output fiber 82, and an aforementioned segmented temperature controllable wavelength conversion device 1 (in particular the wavelength conversion unit 10) of the present invention may be physically connected along an optical path and thus form a fiber pigtailed waveguide mixer 8, further encapsulated as a product.

Optionally or preferably, an input glass ferrule 83 may be added between the input fiber 81 and the segmented temperature controllable wavelength conversion device 1, and/or an output glass ferrule 84 may be added between the segmented temperature controllable wavelength conversion device 1 and the output fiber 82, so as to facilitate coupling between these components.

In such fiber pigtailed waveguide mixer 8, there is no free space existing between these components.

### Free Space Coupled Waveguide Mixer

FIG. 7 shows a schematic diagram of a free space coupled waveguide mixer 9 according to one embodiment of the present invention.

As shown in FIG. 7, an input lens 91, an output lens 92, and an aforementioned segmented temperature controllable wavelength conversion device 1 (in particular the wavelength conversion unit 10) of the present invention may be arranged along an optical path and thus form a free space coupled waveguide mixer 9. In particular, the segmented temperature controllable wavelength conversion device 1 may be arranged between the input lens 91 and the output lens 92, wherein at least one free space may be left between the segmented temperature controllable wavelength conversion device 1 and the output input lens 91 or the segmented temperature controllable wavelength conversion device 1 and the output lens 92.

Optionally or preferably, more input lenses 93 may be added to form a set of input lenses, and/or more output lenses 94 may be added to form a set of output lenses. Herein, any kind of lens is possible as long as it is helpful in focusing a laser light, or coupling the laser in particular from a fiber or a free space into the segmented temperature controllable wavelength conversion device 1. In addition to lens, other optical is also possible to be introduced into the optical path.

### Effect

In conclusion, the present invention provides a wavelength conversion device having a plurality of structurally identical segments operating at different temperatures, which can be used in various applications, such as multiple wavelength conversion, cascade wavelength conversion, yield improvement, and so on, by adjusting the temperatures for the respective segments.

In addition to the possibility of various applications, the present invention has more advantages such as simple manufacturing, reduced cost, and reusability.

Although the present invention has been explained in relation to its preferred embodiment, it is to be understood that many other possible modifications and variations can be made without departing from the spirit and scope of the invention as hereinafter claimed.

What is claimed is:

1. A segmented temperature controllable wavelength conversion device, comprising:
a wavelength conversion unit, including a plurality of segments, wherein a first segment of the segments is configured to operate at a first temperature, a second segment of the segments is configured to operate at a second temperature, and the first temperature is different from the second temperature.

2. The segmented temperature controllable wavelength conversion device as claimed in claim 1, wherein the wavelength conversion unit is formed of periodically poled lithium niobate (PPLN) or periodically poled lithium tantalate (PPLT).

3. The segmented temperature controllable wavelength conversion device as claimed in claim 1, wherein the wavelength conversion unit is in a form of a bulk material with no cutting among the segments.

4. The segmented temperature controllable wavelength conversion device as claimed in claim 1, wherein the segments have the same periodical microstructures or different periodical microstructures.

5. The segmented temperature controllable wavelength conversion device as claimed in claim 1, further comprising:
a plurality of thermal controllers, corresponding respectively to the segments and configured to respectively control a plurality of the temperatures of the segments.

6. The segmented temperature controllable wavelength conversion device as claimed in claim 5, wherein each thermal controller is a chip of a thermal electric cooler (TEC).

7. The segmented temperature controllable wavelength conversion device as claimed in claim 5, further comprising:
a plurality of thermal conductive units, each thermal conductive unit being arranged between a segment and a thermal controller.

8. The segmented temperature controllable wavelength conversion device as claimed in claim 7, further comprising:
a plurality of thermal insulative units, arranged alternatingly with the thermal conductive units.

9. The segmented temperature controllable wavelength conversion device as claimed in claim 7, further comprising:
a plurality of thermal sensors, configured to obtain the temperatures of the segments.

10. The segmented temperature controllable wavelength conversion device as claimed in claim 9, wherein the thermal sensors are arranged respectively in the thermal conductive units.

11. The segmented temperature controllable wavelength conversion device as claimed in claim 1, wherein the first segment is configured to convert a first input wavelength into a first output wavelength, and the second segment is configured to convert a second input wavelength into a second output wavelength.

12. The segmented temperature controllable wavelength conversion device as claimed in claim 11, wherein the first input wavelength is the same as the second input wavelength, but the first output wavelength is different from the second output wavelength.

13. The segmented temperature controllable wavelength conversion device as claimed in claim 11, wherein the first input wavelength is different from the second input wavelength, but the first output wavelength is the same as the second output wavelength.

14. The segmented temperature controllable wavelength conversion device as claimed in claim 11, wherein the first input wavelength is different from the second input wavelength, and the first output wavelength is also different from the second output wavelength.

15. The segmented temperature controllable wavelength conversion device as claimed in claim 1, wherein the segmented temperature controllable wavelength conversion device is capable of receiving at least two different input wavelengths and generating at least two different output wavelengths at a time.

16. The segmented temperature controllable wavelength conversion device as claimed in claim 1, wherein the first segment and the second segment form a cascade structure, configured to perform a cascade wavelength conversion.

17. The segmented temperature controllable wavelength conversion device as claimed in claim 16, wherein the first segment is configured to convert a part of an input into a first output, and the second segment is configured to convert a remaining part of the input along with the first output into a second output.

18. The segmented temperature controllable wavelength conversion device as claimed in claim 17, wherein the cascade wavelength conversion is:
(i) a stage of second harmonic generation plus a stage of sum frequency generation; or
(ii) a stage of second harmonic generation plus another stage of second harmonic generation; or
(iii) a stage of second harmonic generation plus a stage of an optical parametric amplification; or
(iv) a stage of second harmonic generation plus a stage of difference frequency generation; or
(v) any combination of any two processes selected from second harmonic generation, sum frequency generation, optical parametric amplification, and difference frequency generation.

19. The segmented temperature controllable wavelength conversion device as claimed in claim 1, wherein a material variation or a thermal defect in a segment is compensated by independent temperature control of the segment.

20. A fiber pigtailed waveguide mixer, comprising:
an input fiber;
an output fiber; and
a segmented temperature controllable wavelength conversion device as claimed in claim 1, connected between the input fiber and the output fiber.

21. A free space coupled waveguide mixer, comprising:
an input lens;
an output lens; and
a segmented temperature controllable wavelength conversion device as claimed in claim 1, arranged between the input lens and the output lens, wherein at least one free space is left between the segmented temperature controllable wavelength conversion device and the output input lens or the segmented temperature controllable wavelength conversion device and the output lens.
